(19) United States
(12) Patent Application Publication
(10) Pub. No.: US 2017/0094378 A1
(43) Pub. Date: Mar. 30, 2017

(54) Switching Fabric Interface and Scheduling

(71) Applicants: Mohammad Kiaei, Ottawa (CA); Hamid Mehrvar, Ottawa (CA)

(72) Inventors: Mohammad Kiaei, Ottawa (CA); Hamid Mehrvar, Ottawa (CA)

(21) Appl. No.: 15/180,528

(22) Filed: Jun. 13, 2016

Related U.S. Application Data
(60) Provisional application No. 62/233,170, filed on Sep. 25, 2015.
(60) Provisional application No. 62/233,202, filed on Sep. 25, 2015.

(51) Int. Cl. H04Q 11/00; H04B 10/70

(52) U.S. Cl. CPC H04Q 11/0003; H04Q 11/0062; H04B 10/70; H04Q 2011/0086

(57) ABSTRACT

Method and apparatus are provided for controlling an interface to a switch, for example a photonic switch. The method comprises communicatively connecting a controller to a source node and to a destination node; receiving from the source node information indicating a status of at least one input queue at the source node; allocating, based on the information, the at least one input queue to at least one interface of the source node; and aligning frames at the destination node when multiple interfaces of the source node are used for transmission of one input queue. Transmission of one input queue is coordinated via multiple interfaces of the source node. An ingress/egress chip for providing an ingress/egress interface to a photonic switch is also provided.

### TECHNICAL FIELD

The present disclosure generally relates to signal switching, and in particular to switching fabric interfaces and scheduling therefor.

### BACKGROUND

It is desirable to have efficient scheduling for a switching system, because efficient scheduling may reduce delay and increase throughput of a switching system. When a switching system is synchronous and uses buffer-less switching fabrics (such as photonic switching fabrics), buffering may be performed at switching fabric interfaces, for example, at aggregation nodes connected to the switching fabrics. However, conventional synchronous scheduling techniques have somewhat limited performance, particularly when traffic patterns are non-uniform.

An optical switching system can be implemented using electronic switching fabrics or photonic switching fabrics. For a switching system based on electronic switching fabrics, an ingress chip (e.g. in a line card) can be connected to an optical-to-electronic converter to convert an optical signal to an electronic signal for the electronic switching fabrics. Once switched, the electronic signal is converted back to the optical domain by an electronic-to-optical converter which outputs the optical signal to an egress chip. However, multiple optoelectronic and electro-optical conversions are costly, complex, and modulation format dependent.

It is therefore desirable to provide a system and method for synchronous all-optical switching.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In accordance with one aspect of the disclosure, an ingress chip is provided for an ingress interface for connection to a photonic switch. The ingress chip comprises at least one interface connected to the photonic switch for transmission of photonic frames through the photonic switch; an interface allocator for allocating the at least one interface to at least one input queue of packets; at least one photonic framer, each photonic framer being coupled to an interface and configured to group packets into photonic frames for transmission through the photonic switch, and a control channel for communication between the interface allocator and a controller.

In accordance with another aspect of the disclosure, an egress chip is provided for an egress interface for connection to a photonic switch. The egress chip comprises at least one interface connected to the photonic switch for reception of photonic frames from the photonic switch; a stream aligner for aligning photonic frames received from the photonic switch when multiple interfaces are used for receiving from a single source node; at least one photonic de-framer, each photonic de-framer being coupled to an interface and configured to de-frame photonic frames received from the photonic switch into packets; and a control channel for communication between a controller and the stream aligner.

In accordance with yet another aspect of the disclosure, a method is provided for controlling an interface to a switch. The method comprises communicatively connecting a controller to a source node and to a destination node; receiving from the source node information indicating a status of at least one input queue at the source node; allocating, based on the information, the at least one input queue to at least one interface of the source node, wherein transmission of one input queue is coordinated via multiple interfaces of the source node; and aligning frames at the destination node when multiple interfaces of the source node are used for transmission of one input queue. In some embodiments, the switch is a photonic switch.

In accordance with yet another aspect of the disclosure, a controller is provided for controlling an interface to a switch, the controller being communicatively connected between a source node and to a destination node. The controller comprises one or more processors; a memory coupled to the one or more processors having stored thereon machine executable instructions which when executed by the one or more processors, cause the one or more processors to perform: receiving from the source node information indicating a status of at least one input queue at the source node; sending, based on the information, an allocation of at least one interface of the source node for the at least one input queue, wherein transmission of one input queue is coordinated via multiple interfaces of the source node; and controlling alignment of received frames at the destination node when multiple interfaces of the source node are used for transmission of one input queue. In some embodiments, the switch is a photonic switch.

### BRIEF DESCRIPTION OF THE DRAWINGS

These and other features of the disclosure will become more apparent from the description in which reference is made to the following appended drawings.

FIG. 1 schematically depicts a switching system in accordance with an embodiment of the present disclosure.

FIG. 2 schematically depicts an aggregation node in accordance with an embodiment of the present disclosure.

FIG. 3 schematically depicts the system of FIG. 1 in further detail, showing details of a source node, a destination node, and messaging with the controller.

FIG. 4 schematically depicts an example of a two-dimensional transmission, where multiple interfaces are used for simultaneously transmitting packets to one destination top-of-rack (ToR) and to multiple destination ToRs.

FIG. 5 schematically depicts stream alignment in a destination node in accordance with an embodiment of the present disclosure.

FIG. 6A schematically depicts a switching system with a uniform traffic.

FIG. 6B schematically depicts a switching system with a non-uniform traffic.

FIG. 7 depicts average delay versus offered load curves of a linear-summation-based Largest-Queue-First/Starvation Avoidance (LQF/SA) control method (abbreviated as LQF/SA-2 control method), compared to a step-function-based LQF/SA control method (abbreviated as LQF/SA-1 control method).

FIG. 8 depicts maximum delay versus offered load curves of the LQF/SA-2 control method, compared to the LQF/SA-1 method.

FIG. 9A depicts average delay versus offered load curves of a conventional single-interface method (single I/F) under various traffic conditions.

FIG. 9B depicts average delay versus offered load curves of an embodiment of the multiple-interface method (multiple I/F) under various traffic conditions.

FIG. 10A depicts maximum delay versus offered load curves of the conventional single-interface method under various traffic conditions.

FIG. 10B depicts maximum delay versus offered load curves of an embodiment of the multiple-interface method under various traffic conditions.

FIG. 11A depicts average delay versus offered load curves of the conventional single-interface method under stress testing.

FIG. 11B depicts maximum delay versus offered load curves of the conventional single-interface method under stress testing.

FIG. 12A depicts average delay versus offered load curves of an embodiment of the multiple-interface method under stress testing.

FIG. 12B depicts a maximum delay versus offered load curves of an embodiment of the multiple-interface method under stress testing.

FIG. 13 is a flowchart depicting a method of controlling an interface to a switch in accordance with some embodiments of the present disclosure.

FIG. 14 is a flowchart depicting a method of controlling an interface to a switch at a controller in accordance with some embodiments of the present disclosure.

FIG. 15 schematically depicts a controller in accordance with some embodiments of the present disclosure.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the designs and implementations illustrated and described herein, but may be modified within the scope of the appended claims along with their full scope of equivalents.

Disclosed herein are a system and method of providing an interface to a switch and a system and method of controlling the switch interface. Although the following description makes reference to photonic switch(es), photonic switching fabric(s), and particularly photonic switch(es) or switching fabric(s) for data centers, it will be appreciated that the described method and system may be applicable to other switches, switching fabrics, or other synchronous switching infrastructures equipped with buffer-less switches or switching fabrics. For example, the described method and system can be applicable to a switching system with electronic switch(es) or switching fabric(s).

For the purpose of this disclosure, the expressions “controller”, “scheduler’ and “control system” are used to encompass all processors, microprocessors, processing devices, circuits, implementations, units, modules, means, and the like, used for controlling and scheduling. The “controller”, “scheduler”, and/or “control system” may be implemented in hardware, or in a software and/or firmware executed by a processor or microprocessor (with one or more cores) or with multiple connected processors or microprocessors. In some embodiments, the “controller”, “scheduler”, and/or “control system” may comprise an application specific integrated circuit (ASIC) or a field-programmable gate array (FPGA).

According to various embodiments of the disclosure, the controller can be centralized, distributed, or a hybrid of both implementations. In the centralized scenario, the control signals can be customized for one interface chip; and for the distributed scenario, the controller can be made part of the interface chip. The distributed controller can be connected to some or all other interface chips and communicate with each other dependent on the inter-connections. In the following embodiments shown by way of the figures, the controller may be a centralized controller for illustration purposes. The interface chip may comprise a control channel connected to the central controller. It will be appreciated that in other embodiments the controller can be distributed and form part of the interface chip. In such a case, the controller of each chip communicates to the controller of some or all other interface chips through the control channel of the chip and an inter-connecting system that connects these distributed controllers.

In some embodiments, the controller can control all the interfaces of the switch(es) or switching fabric(s); in alternative embodiments, the controller can control one or some of the interfaces of the switch(es) or switching fabric(s). In one embodiment, the controller can be a centralized controller for a photonic switch; in another embodiment, the controller can be a centralized controller for a non-photonic switch; in yet another embodiment, the controller can be a distributed controller for a photonic switch; and in yet another embodiment, the controller can be a distributed controller for a non-photonic switch. The controller and the switch(es) operate in a synchronous time-slot system in the sense that the transmitter and receiver clocks are synchronized per time slot.

An aggregation node (or end node, or simply, node) can include an ingress chip (or chipset) acting as an ingress interface for connectivity to the switch(es) and/or an egress chip (or chipset) acting as an egress interface for connectivity from the switch(es). The ingress chip (or chipset) and egress chip (or chipset) may be implemented as a single chip or on separate chips. The ingress/egress chip may be integrated as part of the node connected to the switch(es). The node can be an aggregation node in a data center, such as a top-of-rack (ToR) or an edge switch. It will be appreciated that depending on the switching system or switching infrastructure, other suitable types of aggregation nodes can be used. By way of the described method and system, input queuing and interface allocation in a source node and output queuing and stream alignment in a destination node can be achieved.

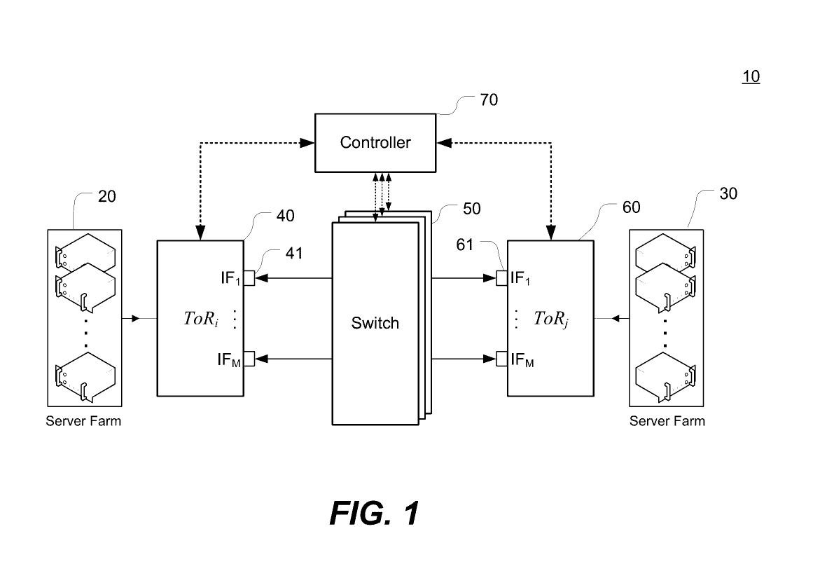

FIG. 1 schematically depicts a switching system 10 in accordance with an embodiment of the present disclosure. This figure shows by way of example switching fabrics (more specifically, core switching fabrics) 50 comprising a stack of photonic switches, such as silicon photonic (SiP) switches. No optical buffer is used for the switches 50 for scalability purposes and to meet cost, power and size requirements. Before sending packets to the switches 50, buffering is performed at aggregation nodes 40, 60 (in electronic domain) connected to the switches 50. In this embodiment the aggregation nodes 40, 60 are ToRs. A controller 70 is provided for controlling aggregation nodes 40, 60, which function as an interface to the buffer-less switches 50.

FIG. 1 further illustrates a plurality of server farms including a first server farm 20 communicatively connected a second server farm 30. One or both farms 20, 30 may be part of a photonic data center (or any other suitable networking or switching infrastructure). The first server farm 20 has a plurality of servers each capable of transmitting and receiving data. Likewise, the second server farm 30 has a plurality of servers each capable of transmitting and receiving data. In order to communicate data signals from one specific server at one farm to another server at the other farm, the data signals are switched at the switches 50.

Between the server farm 20 and the switches 50 is a first aggregation node 40. The first aggregation node 40 in this embodiment is a first ToR. Between the server farm 30 and the switches 50 is a second aggregation node 60. The second aggregation node 60 in this embodiment is a second ToR. Each of the first and second aggregation nodes 40, 60 includes at least one interface connected to the switches 50. For example, the first node 40 has M interfaces 41 (IF₁ to IF_{M}). Similarly, the second node 60 has M interfaces 61 (IF₁ to IF_{M}). Each interface may have one or both of a transmitter and a receiver. Interfaces of each node are connected to the corresponding interfaces of some or all other nodes through the switches 50. For example, IF₁, IF₂, . . . , IF_{M} 41 of the first ToR 40 are connected respectively to IF₁, IF₂, . . . , IF_{M} 61 of the second ToR 60 through the switches 50.

Each node 40, 60 can be used as a source node for transmission of packets through the switches 50 or a destination node for reception of packets from the switches 50. For illustration purposes, the first node 40 is used as the source node and the second node 60 is used as the destination node. As will be explained, the source node 40 communicates information indicating its status of input queues to the controller 70. Based on the information, the controller 70 sends an allocation of interfaces 41 of the source node 40 for the input queues, and controls alignment at the destination node 60 when multiple interfaces 41 of the source node 40 are used for transmission of one input queue.

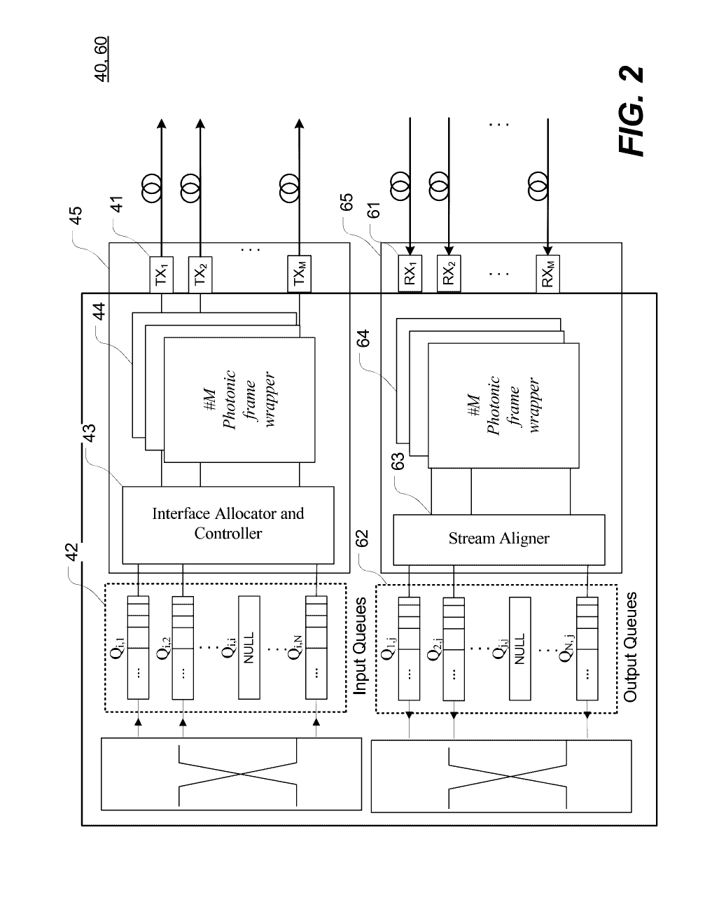

FIG. 2 schematically depicts an aggregation node 40, 60 in accordance with an embodiment of the present disclosure. Each aggregation node 40, 60 can include an ingress chip 45 for providing an ingress interface to the switches 50 and/or an egress chip 65 for providing an egress interface to the switches 50. An aggregation node 40, 60 can be a ToR or an edge switch in a data center. When the switches 50 are photonic switches, the ingress chip 45 can be referred to as the photonic ingress interface (PII) and the egress chip 65 can be referred to as the photonic egress interface (PEI).

In the context of a node being used as a source node, the ingress chip 45 interfaces with the switches 50. Such a node can also be referred to as a transmitter node. In the context of a node being used as a destination node, the egress chip 65 interfaces with the switches 50. Such a node can also be referred to as a receiver node.

As depicted in FIG. 2, the source node 40 includes at least one input queue 42 of packets Q_{i, 1} . . . Q_{i, N} (electronic packets in this embodiment). Each input queue 42 Q_{i, j} (j=1, . . . , N) includes packets to be transmitted from the source node ToRᵢ, to a destination node ToRⱼ. N is the number of nodes other than itself (i≠j). The ingress chip 45 includes at least one interface 41 connected to the switches 50 (FIG. 1) for transmission through the switches 50. In the context of the ingress chip 45, the interfaces 41 refer to the transmitters TX₁, . . . , TX_{M} of the interfaces used for transmission. The ingress chip 45 further includes an interface allocator 43 for allocating the at least one interface for the at least one input queue of packets Q_{i,1} . . . Q_{i,N}. As will be explained in more detail, the interface allocator 43 coordinates transmission of packets designated for a single destination node via at least one interface. As well, the interface allocator 43 coordinates transmission of packets designated for multiple destination nodes via multiple interfaces. The allocation of the at least one interface can be done by the interface allocator 43 in communication with the controller 70 (FIG. 1), which in the embodiment of FIG. 2 is shown as a distributed controller as part of the interface allocator 43. Alternatively in the centralized controlling scenario, the ingress chip 45 can be connected to the controller 70. In either scenario, the ingress chip 45 includes a control channel (not shown) to the controller 70 for communication between the interface allocator 43 and the controller. As will be explained in more detail, the ingress chip 45 can calculate a queue index of each of the input queues 42 based on the length of the input queue and the delay of an oldest packet in the input queue and sorts the queue indexes of the input queues.

When the switches 50 are photonic switches, the ingress chip 45 further includes at least one photonic framer 44 (wrapper) for grouping packets into photonic frames for transmission through the photonic switches. Each photonic framer 44 is coupled to a corresponding interface 41. Using the photonic framer 44, packets are grouped into photonic frames, each frame corresponding to the length of the timeslot. The interface allocator 43 can allocate an input queue to one or multiple photonic framers 44 for transmitting via one or multiple interfaces 41.

As also depicted in FIG. 2, the egress chip 65 includes at least one interface 61 connected to the switches 50 for reception of photonic frames from the switches 50. As described above, the at least one interface 61 correspond to the at least one interface 41 of the ingress chip 45. In the context of the egress chip 65, the interfaces 61 refer to the receivers RX₁, . . . , RX_{M} of the interfaces used for receiving photonic frames from the switches 50. As will be explained in more detail, the egress chip 65 also includes a stream aligner 63 for aligning photonic frames received from the switches 50 when multiple interfaces are used for receiving from a single source node. The stream aligner 63 aligns frames from the single source node via multiple interfaces 61. The alignment can be done by the stream aligner 63 in communication with the controller 70, either in a centralized or distributed manner. In either scenario, the egress chip 65 includes a control channel (not shown) for communication between the stream aligner 63 and the controller 70. In the centralized controlling scenario, the egress chip 65 is connected to a central controller; and in the distributed controlling scenario, the controller can be made part of the chip. The stream aligner 63 can align frames based on an interface counter received from the controller 70. The interface counter, as will be explained, specifies the order of the multiple interfaces used for transmission from a single source node.

When the switches 50 are photonic switches, the egress chip 65 further includes at least one photonic de-framer 64 (unwrapper) for de-framing the photonic frames received from the photonic switches into packets. Each photonic de-framer 64 is coupled to a corresponding interface 61. The stream aligner 63 can align multiple photonic frames (and corresponding packets) received from the multiple interfaces received from a single source node and output them to one output queue 62. This will result in at least one output queue 62 of packets Q_{1,j} . . . Q_{N, j} (optical packets in this embodiment). For example, if three frames are received through interfaces RX₁, RX₄, RX₅ from a single source node, the stream aligner 63 aligns the received frames in the correct order into an output queue.

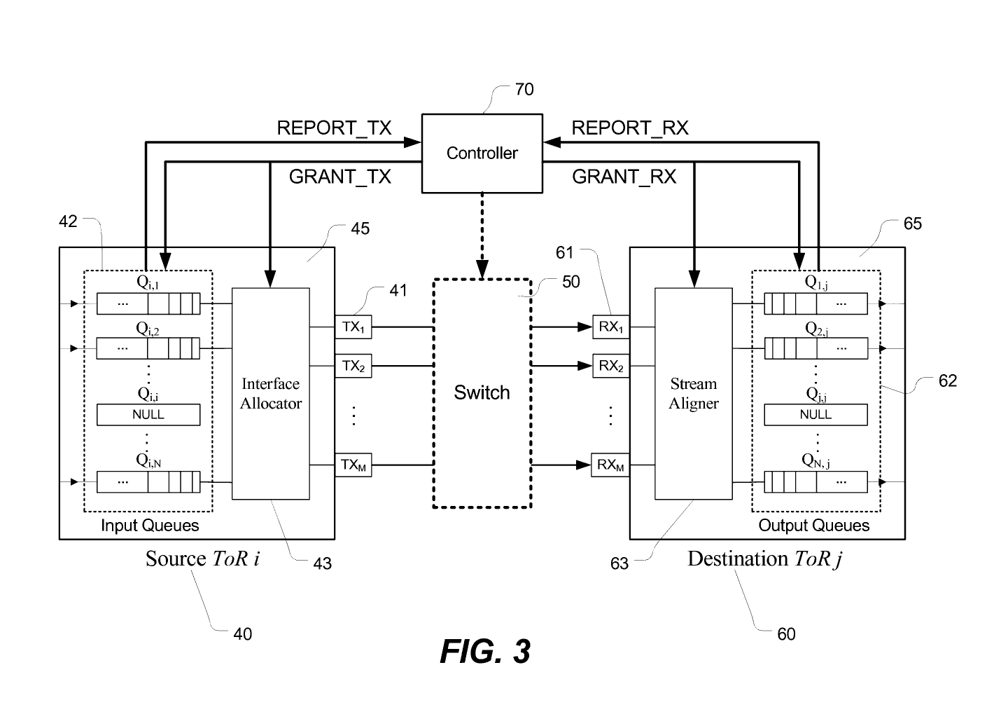

The ingress chip 45 and egress chip 46 may be connected externally to memory units containing the input queue 42 and output queue 62, as shown in FIG. 2. Alternatively, the ingress chip 45 and egress chip 46 may include buffering of the input queue 42 and queuing of the output queue 62, respectively, as part of the chip, as shown in FIG. 3.

FIG. 3 schematically depicts the system of FIG. 1 in further detail, showing details of the source node 40, the destination node 60, and messaging with the controller 70. For simplicity, the photonic framer/de-framer is omitted in this figure. As described above, although the controller 70 is shown as a centralized controller, the controller can be made part of the ingress chip 45 and/or egress chip 65.

As described above, an input queue is received at a source node 40, in this embodiment the source ToR, designated for a destination node 60, in this embodiment the destination ToR. At least one input queue (request) 42 Q_{i, j} (j=1, . . . , N) can be received at the source ToR 40 designated for at least one destination node including the destination ToR 60. As described above, each of the source ToR 40 and the destination ToR 60 includes at least one corresponding interface connected to the switches 50, e.g., the photonic switches. The interface allocator 43 allocates (assigns) the input queue 42 Q_{i, j} to at least one interface 41 of the source ToR 40. In other words, it is possible to assign one input queue 42 to multiple interfaces 41 for simultaneous transmission. For each source ToR 40 in every time slot, any combination of the interfaces 41 can be assigned to one input queue Q_{i, j}, depending on traffic conditions. Packets from the input queue Q_{i, j} are transmitted by the at least one interface 41 through the switch 50 to the destination ToR 60 in one time slot.

According to some embodiments, information indicating a status of the at least one input queue 42 at a source ToR 40 can be reported from the source ToR 40 to the controller 70. As will be explained, a queue index of each input queue 42 can be calculated and indexed, and each queue index can be calculated based on a linear summation of the length of the input queue and a delay of the oldest packet in the input queue. As depicted by way of example in FIG. 3, a transmission report message (REPORT_TX) can be sent from the source ToR 40 to the controller 70. The REPORT_TX message can contain information about the input queue status, e.g. queue length, number of packets, packet delay, or any other such parameters or metrics. A transmission control message, or “grant-of-request” message (GRANT_TX), can be sent from the controller 70 based on a determination made at the controller 70. The GRANT_TX message can inform the interface allocator 43 and input queues 42 of an allocation of the least one interface. The GRANT_TX message can also contain an interface counter (IF_CNT) value for each allocated interface when multiple interfaces are allocated for one input queue for the duration of one time slot.

As further depicted by way of example in FIG. 3, the frames are received at the destination ToR 60 from at least one interface 61 corresponding to the at least one interface 41. The stream aligner 63 aligns the received frames and outputs to the corresponding output queues 62 Q_{i, j} (i=1, . . . , N). In particular, if multiple interfaces are used for one input queue 42, the stream aligner 63 de-queues and aligns frames from the multiple interfaces into one output queue 62.

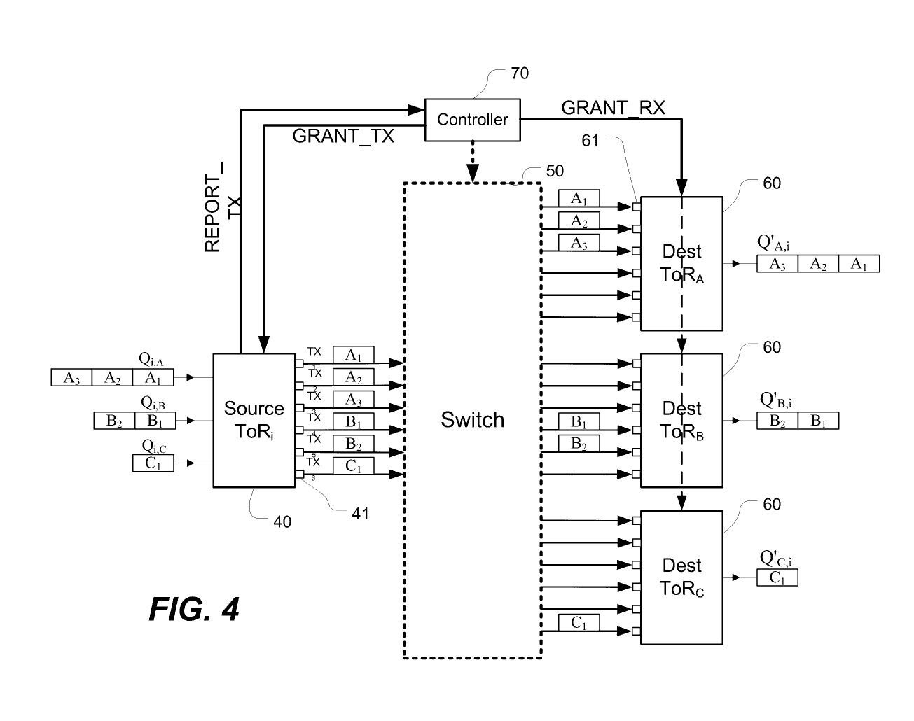

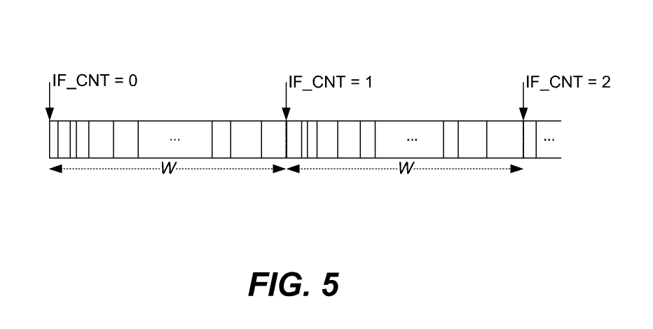

According to some embodiments, the stream aligner 63 aligns the frames based on an interface counter received at the destination node 60. In the embodiment depicted in FIG. 4, a reception control message (GRANT_RX) can be sent from the controller 70 based on the determination made at the controller 70. The GRANT_RX message can inform the destination node 60 of the allocation of the interfaces and also contain the interface counter (IF_CNT) for each allocated interface when multiple interfaces are allocated to one input queue. An example of frame alignment is shown with reference to FIG. 5. A reception report message (REPORT_RX) can also be sent from the destination ToR 60 to the controller 70. The reception report message may contain optional auxiliary information about output queues.

FIG. 4 presents an example of a two-dimensional transmission, where multiple interfaces are used for simultaneously transmitting packets to one destination ToR and to multiple destination ToRs.

In this example, the source ToRᵢ 40 includes three input queues Q_{i,A}, Q_{i,B}, Q_{i,C} to be transmitted to three corresponding destination ToRs 60 denoted as ToR_{A}, ToR_{B} and ToR_{C}, respectively. The input queue Q_{i, A} for destination ToR_{A} may include packets equivalent to three frames A₁, A₂, A₃. The input queue Q_{i,B} for destination ToR_{B} may include packets equivalent to two frames B₁, B₂. The input queue Q_{i,C} for destination ToR_{C} may include packets equivalent to one frame C₁. Q′_{A,i}, Q′_{B,i}, Q′_{C,i} denote the corresponding output queues in the three destination ToRs 60 ToR_{A}, ToR_{B} and ToR_{C}, respectively. In this particular example, each source/destination ToR has six Tx/Rx interfaces. It will be appreciated that there may be other destination ToRs and other corresponding input queues (requests) but omitted for simplicity and illustration purposes. The source ToRᵢ 40 has an ingress chip acting as a PII and each of the destination ToRs 60, ToR_{A}, ToR_{B} and ToR_{C}, has an egress chip acting as a PEI. Referring to FIG. 3, the controller 70 receives information indicating a status of input queues from the source ToRᵢ 40. The controller 70 returns a GRANT_TX message to enable the interface allocator 43 to allocate the input queues to the interfaces 41. As shown in this example, based on the queue status, the interface allocator 43 allocates three interfaces for the input queue Q_{i,A} to be transmitted to the destination ToR_{A}, two interfaces for the input queue Q_{i,B} to be transmitted to the destination ToR_{B}, and one interface for the input queue Q_{i,C} to be transmitted to the destination ToR_{C}. It should be appreciated this example is only provided to illustrate that more than one interface can be allocated for an input queue for a particular destination node and a different allocation of interface can be made. The switches 50 perform the switching by routing frames A₁, A₂, and A₃ to ToR_{A}, routing frames B₁ and B₂ to ToR_{B}, and routing frame C₁ to ToR_{C}, based on any suitable switching routing schemes. The stream aligner 63 at each of the three destination ToRs, ToR_{A}, ToR_{B}, and ToR_{C}, aligns the streams of frames. Note that all six frames are transmitted in a single time slot.

Specifically, the described embodiments enable what is referred to as a “two-dimensional transmission” on multiple interfaces in a single time slot. This two-dimensional transmission includes what is termed “horizontal transmission” to one destination node via at least one interface and “vertical transmission” to multiple destination nodes via multiple interfaces.

The described embodiments also enable what is referred to a “two-dimensional reception” on multiple interfaces in a single time slot. This two-dimensional reception includes a “horizontal reception” of receiving an input queue (request) intended for one particular destination node via at least one interface and a “vertical reception” at multiple destination nodes. In a single time slot, a destination node can receive from one source node using one or more interfaces.

As described above and in accordance with some embodiments, different tasks can be assigned for the controller 70, the source node 40, and the destination node 60.

The controller 70 receives from the source node 40 information indicating a status of input queues 42 at the source node. Based on the information, the controller 70 sends an allocation of interfaces of the source node 40 for the input queues 42, and controls alignment of the frames at the destination node 60 when multiple interfaces of the source node 40 are used for transmission of one input queue 42 (request). A transmission of one input queue 42 (request) is coordinated via multiple interfaces 41 of the source node 40.

As described above, the controller 70 can collect reports from all nodes 40, 60, and sort and grant requests based on their queue statuses. The controller 70 can send the GRANT_TX message containing the allocation of interfaces (empty if no interface is assigned) to the source node 40, and send the GRANT_RX message containing the allocation of interfaces and the interface counter (IF_CNT) to the destination node 60. Any suitable rules can be implemented for bandwidth allocations. Because the interface allocator 43 can allocate an input queue 42 to one or many interfaces 41 in any combination, the controller 70 can grant multiple interfaces for one request depending on the traffic conditions. Such a control or scheduling scheme can be applicable for any synchronous switching system with a buffer-less switch. In any such switching system, the controller can receive information indicating queue status including the bandwidth demand and priority of the input queues (requests). In turn, the controller 70 can allocate multiple interfaces for one input queue based on the bandwidth demand and priority of the queues.

According to some embodiments, only information of a subset of the input queues (requests) 42 is sent from a source node 40 to the controller 70. Each source node 40 contains an input queue 42 for every possible destination node 60. Packets are stored in the corresponding input queue 42 in the source node 40 until the controller 70 allocates an interface for their transmission. The source node 40 can index its queues in terms of a length of each queue and a delay of their respective oldest packet. Accordingly, a queue index of each input queue can be calculated and sorted based on the length of the input queue and the delay of an oldest packet in the input queue. In one particular embodiment, the queue index is calculated based on a linear summation of the length of the input queue and the delay of an oldest packet in the input queue. The sorted queue indexes of the input queues 42 can be sent from the source node 40 to the controller 70 and the controller 70 can return with an allocation of interfaces based on the sorted queue indexes. In one embodiment, the source node 40 can report top R requests to the controller 70 based on the sorted queue indexes. Typically the number M of interfaces for each node is much smaller than the number N of nodes. The subset R of input queues being reported to the controller can be equal or greater than M, and equal or less than N. By way of expression, M≦R≦N.

In accordance with some embodiments, queues can be indexed at a source node ToRᵢ 40 in each time slot as follows.

First a set Xᵢ is created comprised of queuing indexes xᵢⱼ of a source node ToRᵢ to destination node ToRⱼ:

$$\begin{matrix}{X}_{i} = \{ {x}_{ij} \text{:} 0 \leq i , j \leq N , j \neq i \} & ( 1 ) \\ {x}_{ij} = \frac{{q}_{ij}}{{q}_{th}} + \frac{{d}_{ij}}{{d}_{th}} & ( 2 )\end{matrix}$$

where qᵢⱼ is the length of the queue (e.g., number of bits) of the source node ToRᵢ to the destination node ToR₁, dᵢⱼ is the corresponding delay of its oldest packet, qₜₕ is the threshold value of a length of a queue, and dₜₕ is the threshold value of a delay.

Then a destination node ToRⱼ 60 that has the maximum queue index is found based on equation (3) and reported to the controller 70.

$${x}_{ij *} = {max}_{j} ( {x}_{ij} ∈ {X}_{i} ) \qquad ( 3 )$$

The queue index xᵢⱼ, of the reported queue is then updated based on equation

$${x}_{ij *} = \frac{{q}_{{ij}^{*}}^{′}}{{q}_{th}} + \frac{{d}_{{ij}^{*}}^{′}}{{d}_{th}} \\ {d}_{{ij}^{*}}^{′} = \{ \begin{matrix}{d}_{{ij}^{*}} - {T}_{s} & {d}_{{ij}^{*}} \geq {T}_{s} \\ 0 & otherwise\end{matrix} \\ {q}_{{ij}^{*}}^{′} = \{ \begin{matrix}{q}_{{ij}^{*}} - W & {q}_{{ij}^{*}} \geq W \\ 0 & otherwise\end{matrix} \qquad ( 4 )$$

where W is the number of bits transmitted in each time slot, Tₛ is the length of a time slot, and R_{b} is the bit rate. The three parameters satisfy the relationship W=R_{b}×Tₛ.

The operations based on equations (3) and (4) are repeated R times to create R requests to be sent to the controller 70.

When multiple interfaces 41 of the source node 40 are used for transmission of one input queue, aligning the received frames at the destination node 60 is performed based on the interface counter (IF_CNT) sent from the controller 70. The destination node 60 aligns received frames from multiple interfaces 61 based on the interface counter (IF_CNT) received for example, in the GRANT_RX message. FIG. 5 illustrates a technique for stream alignment in a destination node 60. The received stream is stored to the output queue 62 starting from address (IF_CNT×W) where W is the number of bits transmitted in each time slot, as described above.

The disclosed embodiments can be used to address non-uniform traffic distribution inside data centers and facilitate scheduling and bandwidth allocation without data confliction with buffer-less photonic switching fabrics. The disclosed embodiments provide queuing/de-queuing in the source and destination nodes 40, 60 and the ability to assign multiple ToR interfaces to one high-bandwidth transmission request.

Let λ_{i,j} represent a traffic intensity from a source ToR, to a destination ToRⱼ (0≦i≠j<N), traffic distribution can be expressed as:

$${λ}_{i , j} = \{ \begin{matrix}λ ( ω + \frac{1 - ω}{N - 1} ) & if j = S ( i ) \\ λ ( \frac{1 - ω}{N - 1} ) & if j \neq i , j \neq S ( i ) \\ 0 & if j = 1\end{matrix} \qquad ( 5 )$$

where ω is a non-uniformity factor (0≦ω≦1), λ is an aggregated offered load, and S is a permutation table for each input queue.

For every source ToR Tᵢ, there is

$${\sum }_{j = 0}^{N - 1} {λ}_{i , j} = λ$$

When ω=0, it is considered a uniform traffic and equation (5) can be simplified to:

$${λ}_{i , j} = \{ \begin{matrix}\frac{λ}{N - 1} & if j \neq i \\ 0 & if j = i\end{matrix} \qquad ( 6 )$$

When ω=1, it is considered a contention-free traffic and fully unbalanced (or fully non-uniform). Equation (5) can be simplified to:

$${λ}_{i , j} = \{ \begin{matrix}λ & if j = S ( i ) \\ 0 & if j \neq S ( i )\end{matrix} \qquad ( 7 )$$

When the queue index values xᵢⱼ for different destination nodes are generally uniformly distributed, the traffic is considered a uniform traffic.

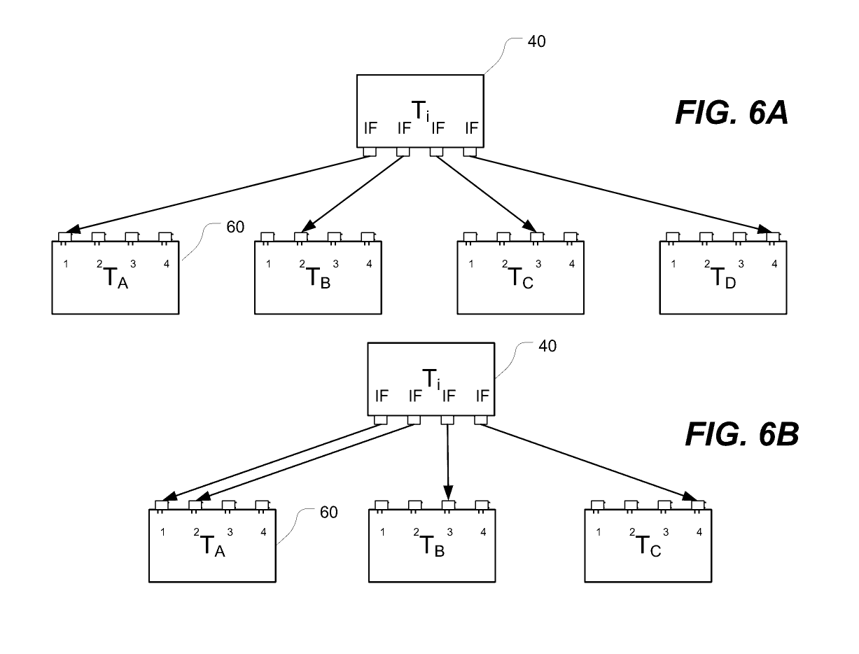

FIGS. 6A and 6B illustrate an example of a switching system with a uniform traffic and an example of a switching system with a non-uniform traffic, respectively. For illustration purposes, a plurality of nodes 40, 60 are provided and each node 40, 60 has four interfaces.

With reference to FIGS. 6A and 6B, four top requests Rᵢ={x_{iA}, x_{iB}, x_{iC}, x_{iD}} of source node Tᵢ to destination nodes T_{A}, T_{B}, T_{C}, and T_{D} are found by the above described method based on equations (1)-(4). x_{iA}, x_{iB}, x_{iC}, x_{iD} represent the queue indexes of the corresponding requests (input queues).

By way of an example as depicted in FIG. 6A, a uniform traffic is represented by queue index values Rᵢ={3.9, 3.1, 2.7, 2.1} which has a small variance between different destination nodes. In the example depicted in FIG. 6B, a non-uniform traffic is represented by queue index values Rᵢ={12.1, 3.6, 2.4, 2.1}, with a larger variance where the queue index for destination node T_{A} is much larger than the average. For non-uniform requests, it is more efficient to assign more than one interface for the top request(s). As a result more than one interface is allocated for the transmission to the destination node T_{A}.

As shown in equation (2), the queue is indexed based on a linear summation or scalarization. This can be compared to a method where a step function is used for the calculation of the queue index.

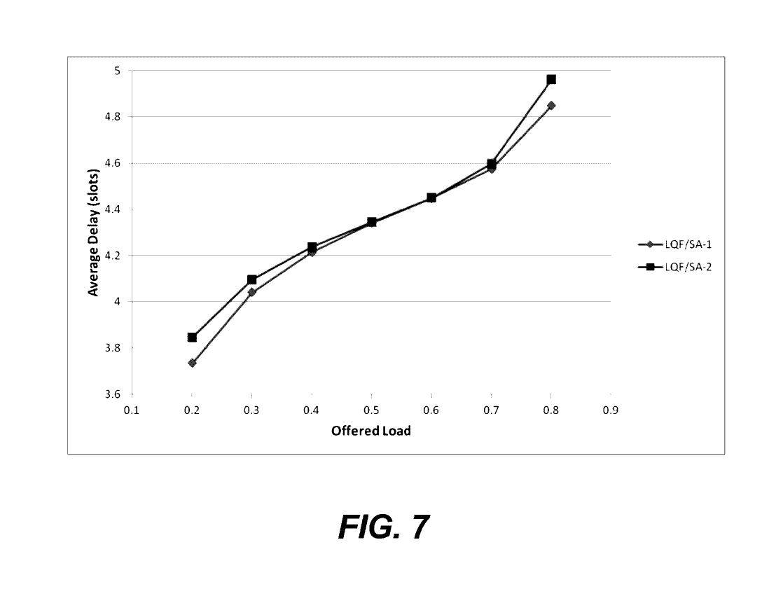

FIG. 7 depicts average delay versus offered load curves of a linear-summation-based Largest-Queue-First/Starvation Avoidance (LQF/SA) control method (abbreviated as LQF/SA-2 control method), compared to a step-function-based LQF/SA control method (abbreviated as LQF/SA-1 control method). The LQF/SA-2 method is based on equation (2) and the LQF/SA-1 method is based on a step function:

$${x}_{ij} = \frac{{q}_{ij}}{{q}_{th}} + \frac{{d}_{ij}}{{d}_{th}} U ( {d}_{ij} - {d}_{th} ) \qquad ( 8 )$$

where U(x) is a step function and the other parameters are the same as in equation (2).

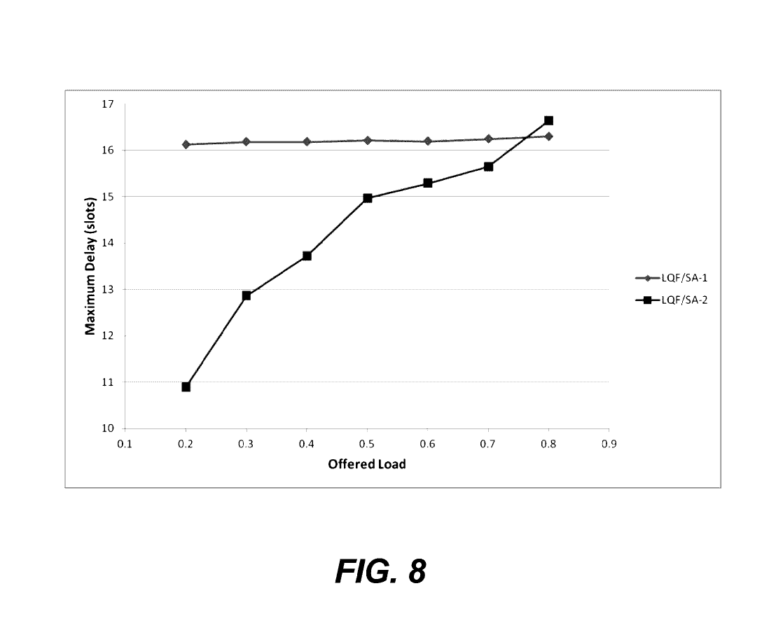

FIG. 8 depicts maximum delay versus offered load curves of the LQF/SA-2 control method, compared to the LQF/SA-1 method.

As depicted by FIGS. 7 and 8, the average delays of LQF/SA-1 and LQF/SA-2 are almost the same, although LQF/SA-2 significantly outperforms LQF/SA-1 in terms of maximum delay.

According to the described embodiments, more than one interface can be assigned to a request in a time slot. Such a method can be referred to as a multiple-interface method. This can be compared to a method where at most one interface can be assigned to each request in a time slot, referred to as a single-interface method.

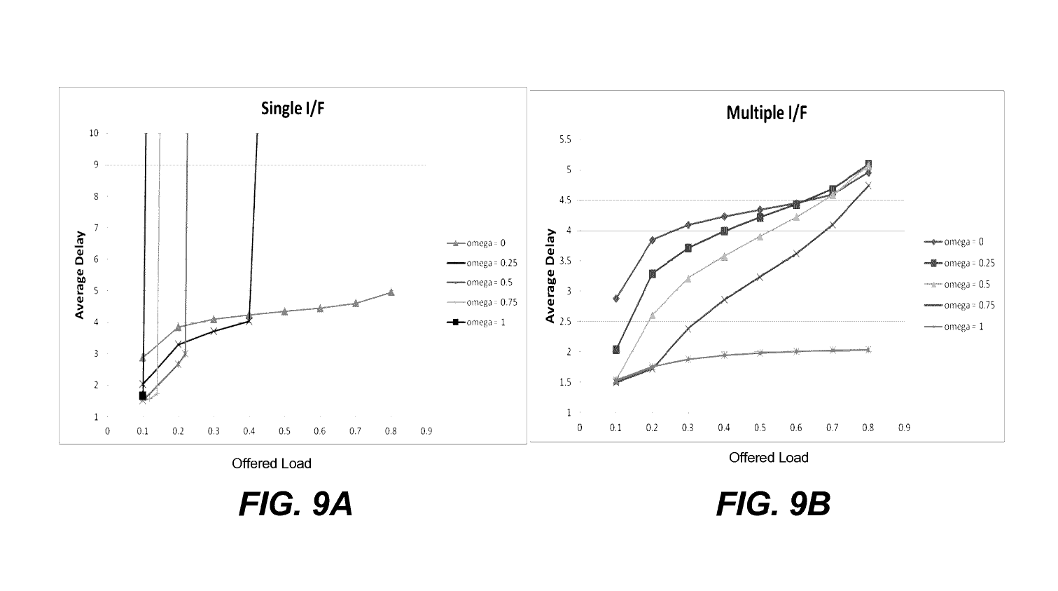

FIG. 9A depicts average delay versus offered load curves of a conventional single-interface method (single I/F) under various traffic conditions, where ω=0, 0.25, 0.5, 0.75, and 1; and FIG. 9B depicts average delay versus offered load curves of an embodiment of the multiple-interface method (multiple I/F) under various traffic conditions.

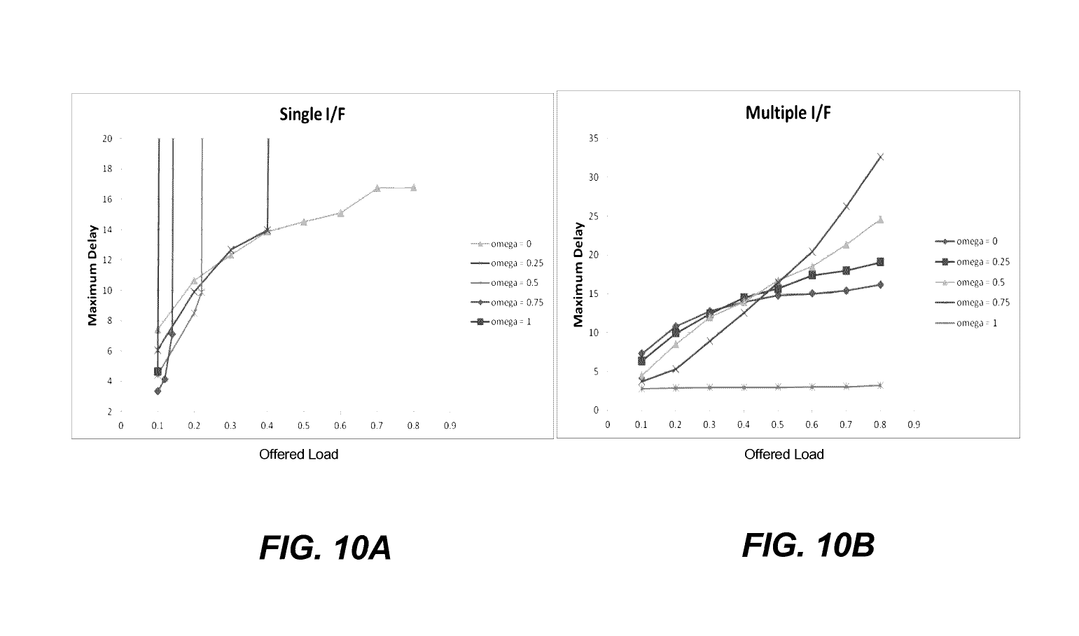

Similarly, FIG. 10A depicts maximum delay versus offered load curves of the conventional single-interface method under various traffic conditions; and FIG. 10B depicts maximum delay versus offered load curves of an embodiment of the multiple-interface method under various traffic conditions.

As shown in FIGS. 9 and 10, compared to the conventional single-interface method that can only assign at most one interface to each request in every time slot, the described multiple-interface method has a significant better performance for traffic patterns where the non-uniformity factor co is greater than zero.

A stress testing can be used for illustration and the stress testing refers to a testing for measuring the effect of periodic transitions between uniform (ω=0) and fully non-uniform traffics (ω=1).

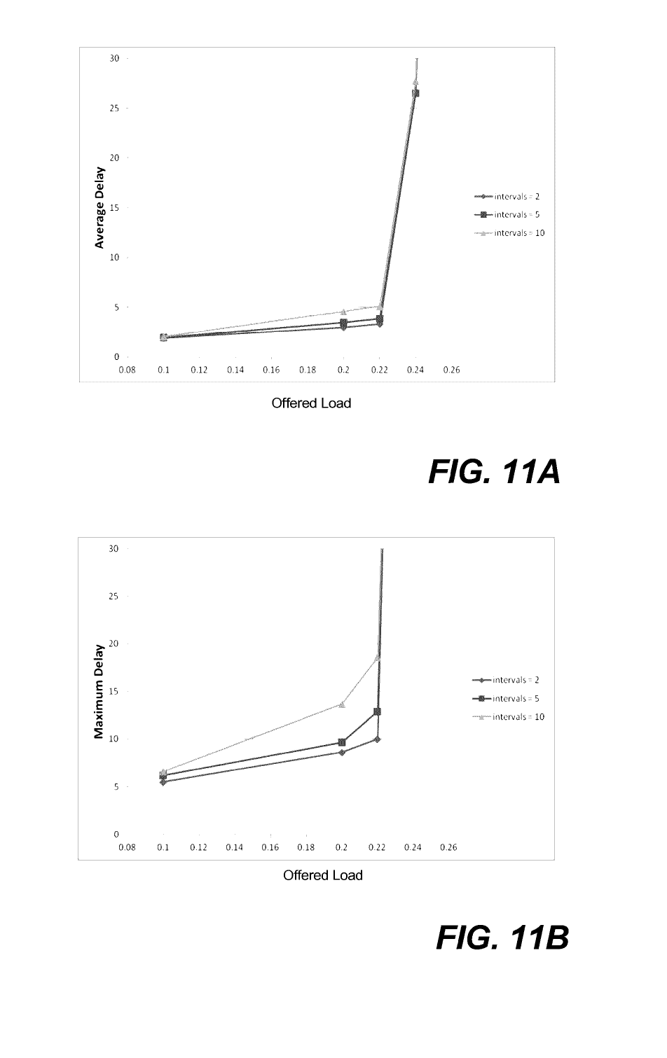

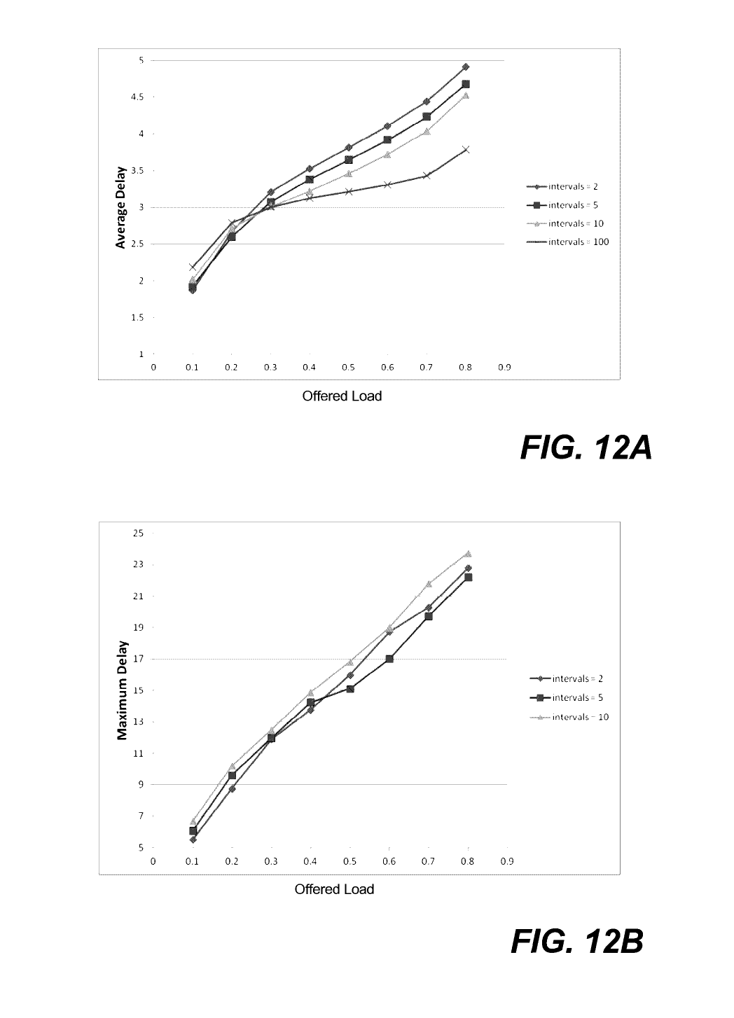

FIG. 11A depicts average delay versus offered load curves of the conventional single-interface method under stress testing. FIG. 11B depicts maximum delay versus offered load curves of the conventional single-interface method under stress testing. FIG. 12A depicts average delay versus offered load curves of an embodiment of the multiple-interface method under stress testing. FIG. 12B depicts a maximum delay versus offered load curves of an embodiment of the multiple-interface method under stress testing.

With reference to FIGS. 11 and 12, the value of the intervals represents the number of time slots for alternating between uniform and fully non-uniform traffics. Compared to the conventional single-interface method, the performances of the multiple-interface method shows significant improvements under stress testing.

The described embodiments therefore significantly improve packet delay performance for non-uniform traffic patterns. For example, a conventional method may provide a maximum throughput of 40% for fully non-uniform traffic. In contrast, some described embodiments can yield a reasonable average and maximum delay for up to 80% throughput (average delay is around 5 time slots for p=0.8).

According to the embodiments described herein, the grant to the source node requests can be based on a linear summation of the length of the queue and the delay of its oldest packet. The described embodiments allow assigning multiple interfaces to queues with larger indexes. The controller can send grant messages to source nodes as well as destination nodes. Destination nodes can perform stream alignment for multiple-interface transmissions.

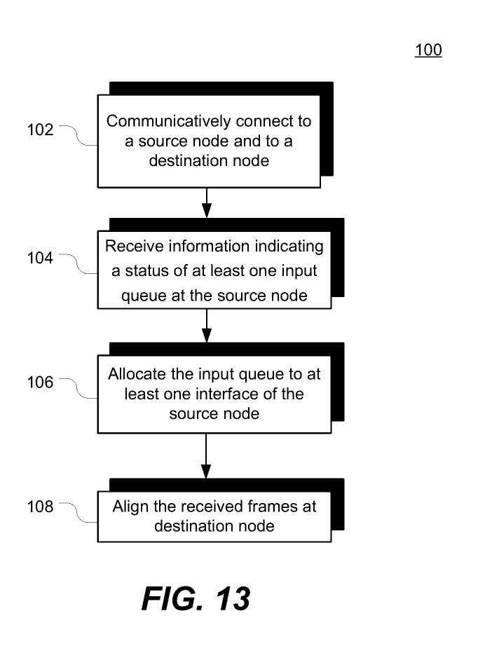

FIG. 13 is a flowchart depicting a method of controlling an interface to a switch in accordance with some embodiments of the present invention. As shown in Figure, the method 100 includes communicatively connecting (102) a controller 70 to a source node 40 and to a destination node 60. The controller 70 can be either distributed, or centralized, or a hybrid of both. Information indicating a status of at least one input queue 42 at the source node 40 is received (104) from the source node 40. Based on the information, the at least one input queue 42 is allocated (106) to at least one interface 41 of the source node 40. As discussed above, transmission of one input queue is coordinated via multiple interfaces 41 of the source node 40. The interface allocation can be sent from the controller 70 to both the source node 40 and the destination node 60. Frames at the destination node 60 are aligned (108) when multiple interfaces 41 of the source node 40 are used for transmission of one input queue. In accordance with the described embodiments, the method enables transmitting an input queue to a single destination node via at least one interface and transmitting input queues to multiple destination nodes via multiple interfaces.

In accordance with some embodiments, at the source node 40, a queue index of each input queue 42 can be calculated and sorted based on a length of the input queue and a delay of an oldest packet in the input queue. In particular, the queue index can be calculated as a linear summation of the length of the queue and the delay of the oldest packet in the queue. The sorted queue index can be sent to the controller 70. The sorted queue index of a subset R of the input queues may be sent to the controller 70. An interface allocation can then be received from the controller 70 based on the sorted queue index. More than one interface can be assigned for a queue based on the sorted queue index. This can occur under non-uniform traffic conditions, for example, when one queue has a much larger queue index. At the destination node 60, the alignment of received frames can be performed based on an interface counter received from the controller 70 when multiple interfaces are used for receiving from a single source node.

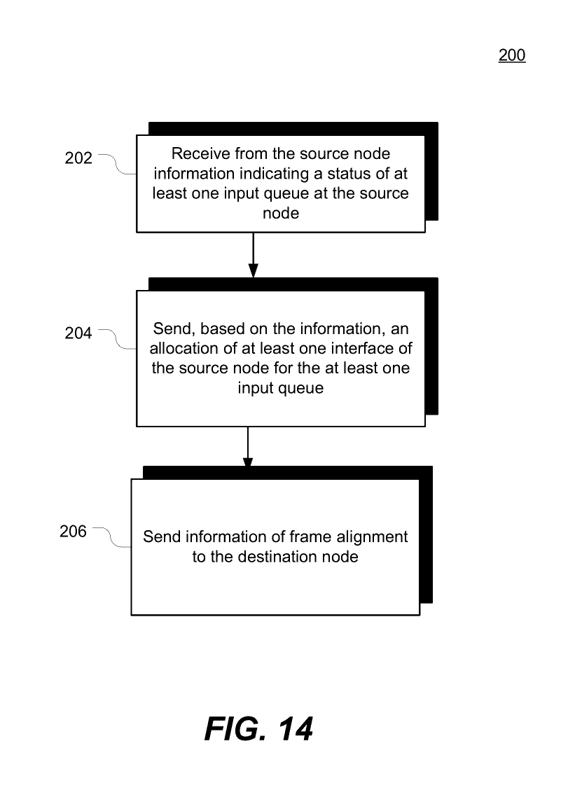

FIG. 14 is a flowchart depicting a method of controlling an interface to a switch at the controller 70 in accordance with some embodiments of the present disclosure. As shown in Figure, the method 200 includes receiving (202), from the source node 40, information indicating a status of at least one input queue 42 at the source node 40. Based on the information, an allocation of at least one interface 41 of the source node 40 is sent (204) for the at least one input queue. The allocation of at least one interface can be sent to both the source node 40 and the destination node 60. A transmission of one input queue is coordinated via multiple interfaces of the source node. The allocation of at least one interface can be based on queue index of the at least one input queue, each queue index being calculated based on a linear summation of the length of the queue and a delay of an oldest packet in the queue. When multiple interfaces 41 of the source node 40 are used for transmission of one input queue, alignment of the received frames at the destination node 60 is controlled by, sending (206) information of frame alignment (such as an interface counter) to the destination node 60.

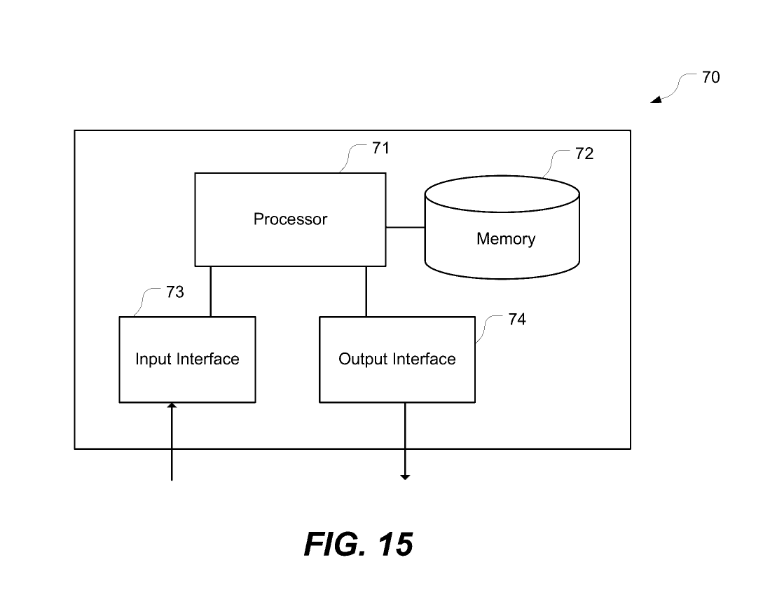

FIG. 15 schematically depicts a controller 70 in accordance with some embodiments of the present disclosure. The controller 70 is communicatively connected to a plurality of aggregation nodes and includes one or more processors 71 and a memory 72 coupled to the one or more processors 71. The memory stores machine executable instructions which when executed by the one or more processors, causes the one or more processors to perform the above described methods. As described above, the controller can be implemented as distributed controllers at the aggregation nodes or a centralized controller. The controller 70 can also include input interface 73 and an output interface 74 in communication with the various elements of the switching system.

According to the described embodiments, for each time slot, multiple interfaces can be assigned for an input queue (or a request) at a source node designated for a destination node. At a destination node packets received from a single source node via multiple interfaces can be aligned.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

What is claimed is:

1. An ingress chip for providing an ingress interface for connection to a photonic switch, the ingress chip comprising:
at least one interface connected to the photonic switch for transmission of photonic frames through the photonic switch;
an interface allocator for allocating the at least one interface to at least one input queue of packets;
at least one photonic framer, each photonic framer being coupled to an interface and configured to group packets into photonic frames for transmission through the photonic switch, and
a control channel for communication between the interface allocator and a controller.

2. The ingress chip of claim 1, wherein the controller and the photonic switch operate in a synchronous time-slot system.

3. The ingress chip of claim 2, wherein the ingress chip is part of an aggregation node of a data center.

4. The ingress chip of claim 1, wherein the ingress chip is configured to:
calculate a queue index for each of the input queue of packets based on a length of the input queue and a delay of an oldest packet in the input queue; and
sort the queue index of the at least one input queue of packets.

5. The ingress chip of claim 4, wherein based on the sorted queue index of the at least one input queue of packets, the ingress chip sends the status of a subset of the at least one input queue of packets to the controller.

6. The ingress chip of claim 4, wherein the queue index is calculated based on a linear summation of the length of the input queue and the delay of an oldest packet in the input queue.

7. The ingress chip of claim 1, wherein the controller is a distributed controller and the ingress chip further comprises a chip controller as part of the distributed controller.

8. The ingress chip of claim 1, wherein the controller is a central controller connected to the ingress chip.

9. An egress chip for providing an egress interface for connection to a photonic switch, the egress chip comprising:
at least one interface connected to the photonic switch for reception of photonic frames from the photonic switch;
a stream aligner for aligning photonic frames received from the photonic switch when multiple interfaces are used for receiving from a single source node;
at least one photonic de-framer, each photonic de-framer being coupled to an interface and configured to de-frame photonic frames received from the photonic switch into packets; and
a control channel for communication between a controller and the stream aligner.

10. The egress chip of claim 9, wherein the controller and the photonic switch operate in a synchronous time-slot system.

11. The egress chip of claim 9, wherein the stream aligner aligns photonic frames received from a same source node based on an interface counter received from the controller.

12. The egress chip of claim 9, wherein the egress chip is part of an aggregation node inside a data center.

13. The egress chip of claim 9, wherein the controller is a distributed controller and the egress chip further comprises a chip controller as part of the distributed controller.

14. The egress chip of claim 9, wherein the controller is a central controller connected to the egress chip.

15. A method of controlling an interface to a switch, the method comprising:
communicatively connecting a controller to a source node and to a destination node;
receiving from the source node information indicating a status of at least one input queue at the source node;
allocating, based on the information, the at least one input queue to at least one interface of the source node, wherein transmission of one input queue is coordinated via multiple interfaces of the source node; and
aligning frames at the destination node when multiple interfaces of the source node are used for transmission of one input queue.

16. The method of claim 15, further comprising:
calculating a queue index of each of the at least one input queue based on a length of the input queue and a delay of an oldest packet in the input queue; and
sorting the queue index of the at least one input queue.

17. The method of claim 16, wherein the queue index is calculated based on a linear summation of the length of the input queue and the delay of the oldest packet in the input queue.

18. The method of claim 17, further comprising:
sending the sorted queue index of the at least one input queue to the controller; and
receiving from the controller an interface allocation based on the sorted queue index.

19. The method of claim 18, wherein sending comprises sending only the sorted queue index of a subset of the at least one input queue to the controller.

20. The method of claim 15, wherein aligning frames at the destination node is performed based on an interface counter received from the controller.

21. The method of claim 15, wherein allocating comprises sending, from the controller, an allocation of interfaces to both the source node and the destination node.

22. The method of claim 15, further comprising transmitting an input queue to a single destination node via at least one of the plurality of interfaces.

23. The method of claim 15, further comprising transmitting multiple input queues to multiple destination nodes via multiple interfaces.

24. The method of claim 15, wherein the switch is a photonic switch.

25. A controller for controlling an interface to a switch, the controller being communicatively connected between a source node and a destination node, the controller comprising:
one or more processors;
a memory coupled to the one or more processors having stored thereon machine executable instructions which when executed by the one or more processors, cause the one or more processors to perform:
receiving from the source node information indicating a status of at least one input queue at the source node;
sending, based on the information, an allocation of at least one interface of the source node for the at least one input queue, wherein transmission of one input queue is coordinated via multiple interfaces of the source node; and
controlling alignment of received frames at the destination node when multiple interfaces of the source node are used for transmission of one input queue.

26. The controller of claim 25, wherein the allocation of at least one interface is based on queue index of the at least one input queue, each queue index being calculated based on a linear summation of the length of the input queue and the delay of the oldest packet in the input queue.

27. The controller of claim 25, wherein controlling includes sending an interface counter to the destination node.

28. The controller of claim 25, wherein the allocation of at least one interface is sent to both the source node and the destination node.

29. The controller of claim 26, wherein the allocation of interfaces is sent to both the source aggregation node and the destination aggregation node.

30. The controller of claim 25, wherein the switch is a photonic switch.
